(19) United States
(12) Patent Application Publication
(10) Pub. No.: US 2008/0055774 A1
(43) Pub. Date: Mar. 6, 2008

(54) Magnetic head and storage medium drive

(75) Inventor: Tetsuyuki Kubota, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/637,910

(22) Filed: Dec. 13, 2006

(30) Foreign Application Priority Data
Aug. 29, 2006 (JP) 2006-232856

(51) Int. Cl. G11B 5/127

(52) U.S. Cl. 360/110

(57) ABSTRACT

A read element is located between lower and upper shielding layers. The read element is connected separately to the lower and upper shielding layers. A first insulating layer and a second insulating layer are located between the lower shielding layer and the slider body. The first insulating layer has a first relative permittivity. The second insulating layer has a second relative permittivity larger than the first relative permittivity. Adjustment of the relative permittivities and/or the thicknesses of the first and second insulating layers allows a change in the relative permittivity of the insulating layer between the lower shielding layer and the slider body. This results in a change in the capacitance between the lower shielding layer and the slider body. The first and second insulating layers of the type contribute to an accurate readout of magnetic bit data irrespective of noise generated on the slider body.

### BACKGROUND OF THE INVENTION

1. Field of the Invention

The present invention relates to a magnetic head incorporated in a storage medium drive such as a hard disk drive, HDD.

2. Description of the Prior Art

A head protection film is overlaid on the outflow or trailing end of a slider body in a head slider incorporated in the hard disk drive, for example. A magnetic head is embedded within the head protection film. The magnetic head includes a read head. The read head includes a lower shielding layer, an upper shielding layer extending along a plane parallel to the lower shielding layer, and a tunnel-junction film located between the lower and upper shielding layers, for example. The tunnel-junction film is electrically connected separately to the lower and upper shielding layers. Each of the lower and upper shielding layers is electrically connected to a lead. The lead and the lower shielding layer in combination establish a first read wire. The lead and the upper shielding layer in combination establish a second read wire.

The slider body serves as a ground in the head slider. The slider body serves to establish the capacitances of the read wires. The slider body sometimes receives an electromagnetic wave from the outside, for example. The electromagnetic wave induces noise on the slider body. In the case where the capacitances of the read wires are different from each other, the noise causes a difference in the potential between the read wires. If this potential is superimposed on the potential caused by a variation in the electric resistance of the tunnel-junction film, the variation cannot be detected with accuracy in the electric resistance of the tunnel-junction film. Magnetic bit data cannot be read out with accuracy.

If the capacitances of the read wires are set equal to each other, no difference is caused in the potential between the read wires regardless of the noise. The capacitances of the read wires can be adjusted by changing a distance between the upper shielding layer and the slider body in the head slider as conventionally known, for example. The capacitances are in this manner set equal to each other. However, a change of the distance leads to a change in the flying height of the head slider and the magnetic characteristic of the magnetic head. The head slider is forced to suffer from a significant design change.

### SUMMARY OF THE INVENTION

It is accordingly an object of the present invention to provide a magnetic head allowing an easier adjustment of the capacitance of a read wire.

According to a first aspect of the present invention, there is provided a magnetic head comprising: a lower shielding layer formed on a slider body; an upper shielding layer extending along a plane parallel to the lower shielding layer; and a read element located between the lower and upper shielding layers, the read element electrically connected separately to the lower and upper shielding layers, respectively. A first insulating layer having a first thickness and a second insulating layer having a second thickness are located between the lower shielding layer and the slider body. The first insulating layer has a first relative permittivity. The second insulating layer has a second relative permittivity larger than the first relative permittivity.

The magnetic head allows establishment of electrical connection between the read element and each of the lower and upper shielding layers. The lower and upper shielding layers serve as read wires. The first and second insulating layers are located between the lower shielding layer and the slider body. The second insulating layer has the second relative permittivity larger than the first relative permittivity. Adjustment of the relative permittivities and/or the thicknesses of the first and second insulating layers allows a change in the relative permittivity of the insulating layer between the lower shielding layer and the slider body. This results in a change in the capacitance between the lower shielding layer and the slider body. The capacitances of the read wires on the slider body can be adjusted in such a facilitated manner. The capacitances of the read wires can be brought in conformity with each other, for example. The first and second insulating layers of the type contribute to an accurate readout of magnetic bit data irrespective of noise generated on the slider body.

In this case, the total thickness of the first and second insulating layers can be kept equal to the thickness of a conventional insulating layer located between the lower shielding layer and the slider body. The distance can be kept as ever between the lower shielding layer and the slider body in the magnetic head. The shapes and sizes of the lower and upper shielding layers can be kept as ever. The magnetic head thus needs not be subjected to a design change. The magnetic head of this type may be incorporated in a storage medium drive, for example.

According to a second aspect of the present invention, there is provided a magnetic head comprising: a lower shielding layer formed on a slider body; an upper shielding layer extending along a plane parallel to the lower shielding layer; a read element located between the lower and upper shielding layers, the read element electrically connected separately to the lower and upper shielding layers, respectively; and a magnetic pole layer extending along a plane parallel to the upper shielding layer. A first insulating layer having a first thickness and a second insulating layer having a second thickness are located between the magnetic pole layer and the upper shielding layer. The first insulating layer has a first relative permittivity. The second insulating layer has a second relative permittivity larger than the first relative permittivity.

The magnetic head allows establishment of electrical connection between the read element and each of the lower and upper shielding layers in the same manner as described above. The lower and upper shielding layers serve as read wires. The magnetic pole layer extends along a plane parallel to the upper shielding layer. The first and second insulating layers are located between the magnetic pole layer and the upper shielding layer. The second insulating layer has the second relative permittivity larger than the first relative permittivity. Adjustment of the relative permittivities and/or the thicknesses of the first and second insulating layers allows a change in the relative permittivity of the insulating layer between the magnetic pole layer and the upper shielding layer. This results in a change in the capacitance between the magnetic pole layer and the upper shielding layer. The capacitances of the read wires on the slider body can be adjusted in such a facilitated manner. The capacitances of the read wires can be brought in conformity with each other, for example. The first and second insulating layers of the type contribute to an accurate readout of magnetic bit data irrespective of noise generated on the slider body.

In this case, the total thickness of the first and second insulating layers can be kept equal to the thickness of a conventional insulating layer located between the lower shielding layer and the slider body. The distance can be kept as ever between the magnetic pole layer and the upper shielding layer in the magnetic head. The shapes and sizes of the lower and upper shielding layers can be kept as ever. The magnetic head thus needs not be subjected to a design change. The magnetic head of this type may be incorporated in a storage medium drive, for example.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the inner structure of a hard disk drive, HDD, as an example of a storage medium drive according to the present invention;

FIG. 2 is a perspective view schematically illustrating a flying head slider according to an embodiment of the present invention;

FIG. 3 is an enlarged front view of a magnetic head observed at a medium-opposed surface or air bearing surface;

FIG. 4 is a sectional view taken along the line 4-4 in FIG. 3;

FIG. 5 is an enlarged partial perspective view schematically illustrating the structure of wiring patterns and electrode terminals on the flying head slider;

FIG. 6 is a graph showing the relationship between the ratio of the capacitances and the ratio of the thicknesses of first and second insulating layers; and

FIG. 7 is a sectional view of a flying head slider, corresponding to FIG. 4, schematically illustrating a magnetic head according to another embodiment of the present invention.

### DESCRIPTION OF THE PREFERRED EMBODIMENTS

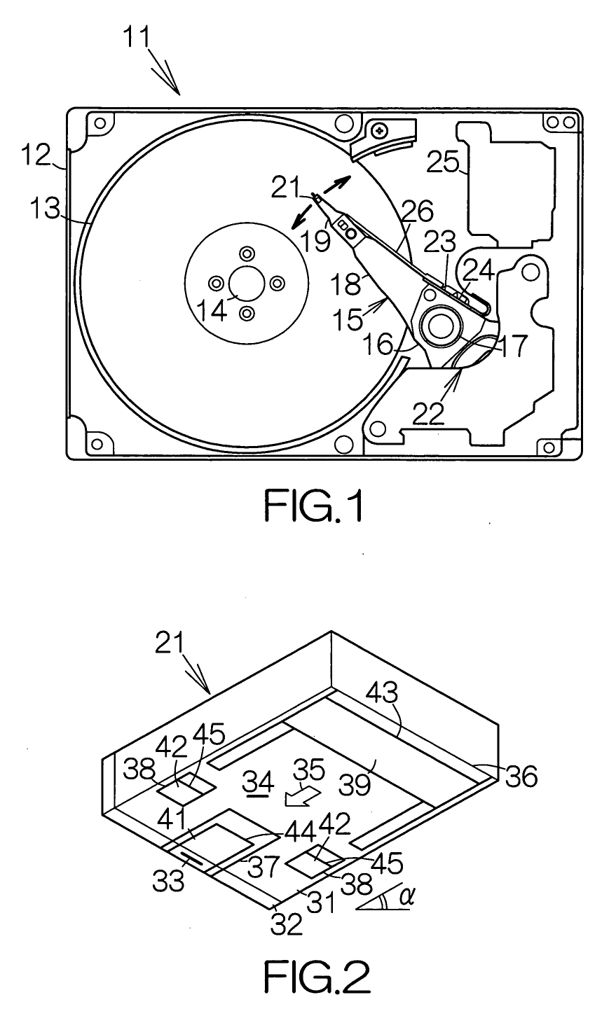

FIG. 1 schematically illustrates the inner structure of a hard disk drive, HDD, 11 as an example of a storage medium drive or a storage device according to the present invention. The hard disk drive 11 includes a box-shaped enclosure body 12 defining an inner space in the form of a flat parallelepiped, for example. The enclosure body 12 may be made of a metallic material such as aluminum, for example. Molding process may be employed to form the enclosure body 12. An enclosure cover, not shown, is coupled to the enclosure body 12. An inner space is defined between the enclosure body 12 and the enclosure cover. Pressing process may be employed to form the enclosure cover out of a plate material, for example. The enclosure body 12 and the enclosure cover in combination establish an enclosure.

At least one magnetic recording disk 13 as a storage medium is enclosed in the enclosure body 12. The magnetic recording disk or disks 13 are mounted on the driving shaft of a spindle motor 14. The spindle motor 14 drives the magnetic recording disk or disks 13 at a higher revolution speed such as 5,400 rpm, 7,200 rpm, 10,000 rpm, 15,000 rpm, or the like.

A head actuator member or carriage 15 is also enclosed in the enclosure body 12. The carriage 15 includes a carriage block 16. The carriage block 16 is supported on a vertical support shaft 17 for relative rotation. Carriage arms 18 are defined in the carriage block 16. The carriage arms 18 are designed to extend in the horizontal direction from the vertical support shaft 17. The carriage block 16 may be made of aluminum, for example. Extrusion molding process may be employed to form the carriage block 16, for example.

Ahead suspension 19 is fixed to the tip end of the individual carriage arm 18. The head suspension 19 is designed to extend forward from the tip end of the carriage arm 18. A gimbal spring, not shown, is connected to the tip end of the individual head suspension 19. A flying head slider 21 is fixed to the surface of the gimbal spring. The gimbal spring allows the flying head slider 21 to change its attitude relative to the head suspension 19. The aftermentioned magnetic head is mounted on the flying head slider 21.

When the magnetic recording disk 13 rotates, the flying head slider 21 is allowed to receive an airflow generated along the rotating magnetic recording disk 13. The airflow serves to generate a positive pressure or a lift as well as a negative pressure on the flying head slider 21. The flying head slider 21 is thus allowed to keep flying above the surface of the magnetic recording disk 13 during the rotation of the magnetic recording disk 13 at a higher stability established by the balance between the urging force of the head suspension 19 and the combination of the lift and the negative pressure.

When the carriage 15 swings around the vertical support shaft 17 during the flight of the flying head slider 21, the flying head slider 21 is allowed to move along the radial direction of the magnetic recording disk 13. A magnetic head on the flying head slider 21 is thus allowed to cross the data zone defined between the innermost and outermost recording tracks. A magnetic head on the flying head slider 21 is positioned right above a target recording track on the magnetic recording disk 13.

A power source or voice coil motor, VCM, 22 is coupled to the carriage block 16. The voice coil motor 22 serves to drive the carriage block 16 around the vertical support shaft 17. The rotation of the carriage block 16 allows the carriage arms 18 and the head suspensions 19 to swing.

A flexible printed wiring board 23 is located on the carriage block 16. A head IC (integrated circuit) 24 is mounted on the flexible printed wiring board 23. The head IC 24 is designed to supply the read element of the magnetic head with a sensing current when the magnetic bit data is to be read. The head IC 24 is also designed to supply the write element of the magnetic head with a writing current when the magnetic bit data is to be written. A small-sized circuit board 25 is located within the inner space of the enclosure body 12. A printed wiring board, not shown, is attached to the back surface of the bottom plate of the enclosure body 12. The small-sized circuit board 25 and the printed wiring board are designed to supply the head IC 24 with the sensing current and the writing current.

A flexible printed wiring board 26 is utilized to supply the sensing current and writing current. The flexible printed wiring board 26 is related to the individual flying head slider 21. The flexible printed wiring board 26 includes a metallic thin film made of stainless steel or the like, an insulating layer, an electrically-conductive layer and a protection layer. The insulating layer, the electrically-conductive layer and the protection layer are overlaid on the metallic thin film in this sequence. The electrically-conductive layer includes a wiring pattern, not shown, extending along the flexible printed wiring board 26. The electrically-conductive layer may be made of an electrically-conductive material such as copper. The insulating layer and the protection layer may be made of a resin material such as polyimide resin.

The wiring pattern on the flexible printed wiring board 26 is connected to the flying head slider 21. The flexible printed wiring board 26 extends backward along the side of the carriage arm 18 from the head suspension 19. The rear end of the flexible printed wiring board 26 is connected to the flexible printed wiring board 23. The wiring pattern on the flexible printed wiring board 26 is connected to a wiring pattern, not shown, on the flexible printed wiring board 23. Electrical connection is in this manner established between the flying head slider 21 and the flexible printed wiring board 23.

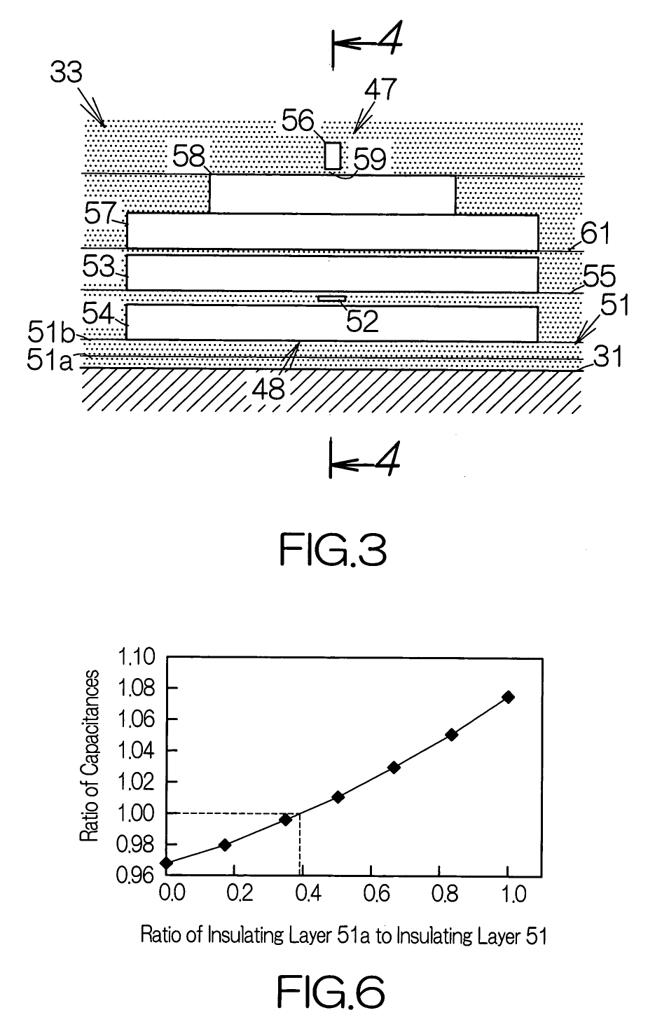

FIG. 2 illustrates a specific example of the flying head slider 21. The flying head slider 21 includes a slider body 31 in the form of a flat parallelepiped, for example. The slider body 31 is made of Al₂O₃—Tic. A head protection film 32 is over laid on the outflow or trailing end of the slider body 31. The head protection film 32 is made of Al₂O₃ (alumina). The aforementioned magnetic head, namely a magnetic head 33, is embedded within the head protection film 32. A medium-opposed surface or bottom surface 34 is defined over the slider body 31 so as to face the magnetic recording disk 13 at a distance. A flat base surface or reference surface is defined on the bottom surface 34. When the magnetic recording disk 13 rotates, airflow 35 flows along the bottom surface 34 from the inflow or front end toward the outflow or rear end of the slider body 31.

A front rail 36, a rear center rail 37 and a pair of rear side rails 38, 38 are formed on the bottom surface 34 of the slider body 31. The front rail 36 stands upright from the base surface of the bottom surface 34 near the inflow end of the slider body 31. The rear center rail 37 stands upright from the base surface of the bottom surface 34 near the outflow end of the slider body 31. The rear side rails 38, 38 stand upright from the base surface of the bottom surface 34 near the outflow end of the slider body 31. The rear center rail 37 is located in a space between the rear side rails 38, 38. Air bearing surfaces, ABSs, 39, 41, 42 are respectively defined on the top surfaces of the rails 36, 37, 38. The inflow ends of the air bearing surfaces 39, 41, 42 are connected to the top surfaces of the rails 36, 37, 38 through steps 43, 44, 45, respectively.

The bottom surface 34 of the flying head slider 21 is designed to receive the airflow 35 generated along the rotating magnetic recording disk 13. The steps 43, 44, 45 serve to generate a larger positive pressure or lift at the air bearing surfaces 39, 41, 42, respectively. Moreover, a larger negative pressure is induced behind the front rail 36. The negative pressure is balanced with the lift so as to stably establish the flying attitude of the flying head slider 21.

The read gap and the write gap of the magnetic head 33 are exposed at the air bearing surface 41 of the rear center rail 37. In this case, the front end of the magnetic head 33 may be covered with a protection layer, made of diamond-like-carbon (DLC), extending over the air bearing surface 41. The magnetic head 33 will be described later in detail. The flying head slider 21 may take any shape or form other than the aforementioned one.

A larger positive pressure or lift is generated at the air bearing surface 39 as compared with the air bearing surfaces 41, 42 in the flying head slider 21. When the slider body 31 flies above the surface of the magnetic recording disk 13, the slider body 31 can be kept at an inclined attitude defined by a pitch angle α. The term “pitch angle” is used to define an inclined angle in the longitudinal direction of the slider body 31 along the direction of the airflow.

FIG. 3 illustrates the bottom surface 34 of the flying head slider 21 in detail. The magnetic head 33 includes a write head 47 and a read head 48. As conventionally known, the write head 47 utilizes a magnetic field generated at a magnetic coil for writing binary data into the magnetic recording disk 13, for example. A magnetoresistive (MR) element such as a giant magnetoresistive (GMR) element, a tunnel-junction magnetoresistive (TMR) element, or the like, may be employed as the read head 48. The read head 48 is usually designed to detect binary data based on variation in the electric resistance in response to the inversion of polarization in the magnetic field applied from the magnetic recording disk 13.

The write and read head 47, 48 are formed on an insulating layer 51. The insulating layer 51 includes a first insulating layer 51a having a first thickness and a second insulating layer 51b having a second thickness. The first insulating layer 51a is overlaid on the outflow end of the slider body 31. The second insulating layer 51b is overlaid on the upper surface of the first insulating layer 51a. The first insulating layer 51a may be made of a dielectric having a first relative permittivity. The second insulating layer 51b may be made of a dielectric having a second relative permittivity different from the first relative permittivity. The dielectric includes Al₂O₃ and SiO₂.

The first and second relative permittivities may be determined depending on the capacitance of the aftermentioned read wires for the slider body 31. Here, the first relative permittivity may be set larger than the second relative permittivity. A specific method of forming Al₂O₃ may be selected to set the first and second relative permittivities at desired values, for example, as described later in detail. Alternatively, the first insulating layer 51a may be made of Al₂O₃ so as to realize the first relative permittivity while the second insulating layer 51b may be made of SiO₂ so as to realize the second relative permittivity, for example.

The read head 48 includes a read element, namely a magnetoresistive film 52. The magnetoresistive film 52 is located between a pair of electrically-conductive layers, namely upper and lower shielding layers 53, 54. The upper shielding layer 53 is designed to extend along a plane parallel to the lower shielding layer 54. The upper and lower shielding layers 53, 54 may be made of a magnetic material such as FeN, NiFe, or the like. The aforementioned insulating layer 51 is located between the lower shielding layer 54 and the slider body 31.

A spin valve film may be employed as the magnetoresistive film 52 in the giant magnetoresistive element, for example. A tunnel-junction film may be employed as the magnetoresistive film 52 in the tunnel-junction magnetoresistive element, for example. A pinning antiferromagnetic layer, a pinned ferromagnetic layer, an insulating layer and a free ferromagnetic layer are overlaid in this sequence in the tunnel-junction film, for example. A pinning antiferromagnetic layer, a pinned ferromagnetic layer, an electrically-conductive layer and a free ferromagnetic layer are overlaid in this sequence in the spin valve film, for example.

The magnetoresistive film 52 is embedded within an insulating layer 55 covering over the upper surface of the lower shielding layer 54. The insulating layer 55 is made of Al₂O₃, for example. The upper shielding layer 53 extends along the upper surface of the insulating layer 55. The lower shielding layer 54 extends along the upper surface of the insulating layer 51. The magnetoresistive film 52 is electrically connected separately to the lower and upper shielding layers 54, 53. A gap between the upper and lower shielding layers 53, 54 determines a linear resolution of magnetic recordation on the magnetic recording disk 13 along the recording track.

The write head 47 includes electrically-conductive layers or upper and lower magnetic pole layers 56, 57. The front ends of the upper and lower magnetic pole layers 56, 57 are exposed at the air bearing surface 41. The upper and lower magnetic pole layers 56, 57 serve as magnetic pole layers according to the invention. The lower magnetic pole layer 57 extends along a plane parallel to the upper shielding layer 53. A front end pole layer 58 is formed on the lower magnetic pole layer 57. The front end of the front end pole layer 58 is exposed at the air bearing surface 41. The upper and lower magnetic pole layers 56, 57 and the front end pole layer 58 may be made of FeN, NiFe, or the like. The upper and lower magnetic pole layers 56, 57 and the front end pole layer 58 in combination serve as a magnetic core of the write head 47.

The front end pole layer 58 is opposed to the upper magnetic pole layer 56. A non-magnetic gap layer 59 made of Al₂O₃ or the like is interposed between the upper magnetic pole layer 56 and the front end pole layer 58. As conventionally known, when a magnetic field is generated in the aftermentioned magnetic coil, the non-magnetic gap layer 59 serves to leak a magnetic flux between the upper and lower magnetic pole layers 56, 57 out of the bottom surface 34. The leaked magnetic flux forms a magnetic field for recordation.

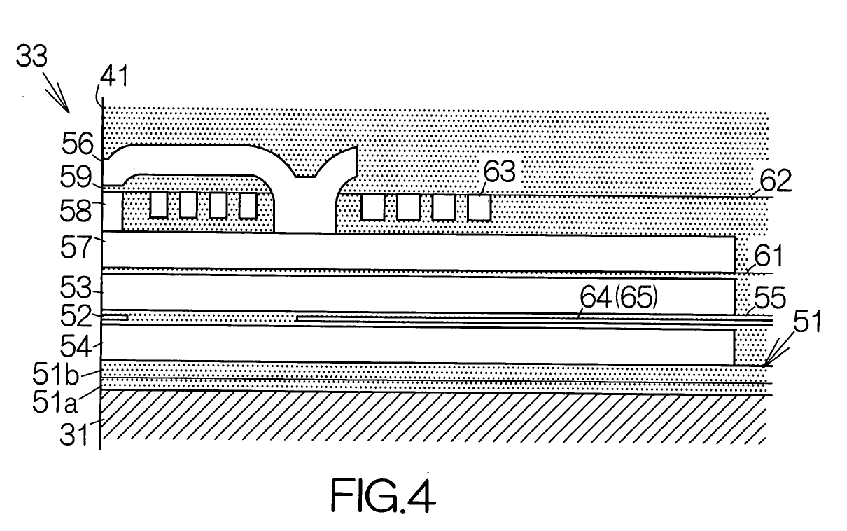

Referring also to FIG. 4, the lower magnetic pole layer 57 is formed on a non-magnetic layer, namely an insulating layer 61, overlaid on the upper shielding layer 53 by a constant thickness. The insulating layer 61 serves to magnetically isolate the lower magnetic pole layer 57 from the upper shielding layer 53. The magnetic coil, namely a thin film coil 63, is formed on the lower magnetic pole layer 57. The thin film coil 63 is embedded within an insulating layer 62. The aforementioned upper magnetic pole layer 56 is formed on the upper surface of the non-magnetic gap layer 59. The rear end of the upper magnetic pole layer 56 is magnetically connected to the lower magnetic pole layer 57 at the center of the thin film coil 63. The upper and lower magnetic pole layers 56, 57 in combination serve as a magnetic core extending through the center of the thin film coil 63.

First and second leads 64, 65 are located between the upper and lower shielding layers 53, 54. The first and second leads 64, 65 are embedded within the insulating layer 55. The first lead 64 is electrically connected to the upper shielding layer 53. The second lead 65 is electrically connected to the lower shielding layer 54. The upper and lower shielding layers 53, 54 are supplied with a sensing current from the first and second leads 64, 65 as described later in detail.

The aforementioned insulating layer 51 is overlaid over the entire outflow end of the slider body 31. The insulating layer 51 thus extends wider than the lower shielding layer 54. The insulating layer 51 or first and second insulating layers 51a, 51b are located between the first lead 64 and the slider body 31. Likewise, the first and second insulating layers 51a, 51b are located between the second lead 65 and the slider body 31.

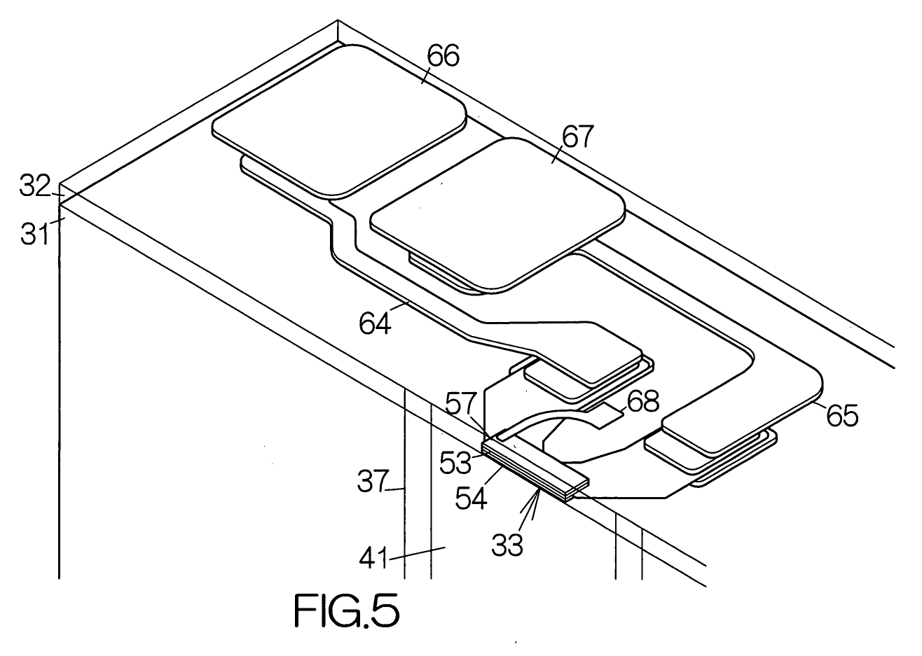

As shown in FIG. 5, first and second electrode terminals 66, 67 are located on the outflow end of the flying head slider 21 or the surface of the head protection film 32. The first electrode terminal 66 is electrically connected to the aforementioned first lead 64. The second electrode terminal 67 is electrically connected to the aforementioned second lead 65. The first and second electrode terminals 66, 67 are electrically connected to the wiring pattern on the flexible printed wiring board 26. Here, the first lead 64 and the upper shielding layer 53 in combination establish a first read wire. The second lead 65 and the lower shielding layer 54 establish a second read wire.

The magnetoresistive film 52 of the read head 48 is supplied with a sensing current from the first electrode terminal 66. The sensing current runs through the magnetoresistive film 52 to the second electrode terminal 67. The electric resistance varies in the magnetoresistive film 52 in response to the inversion of polarization in the magnetic field applied from the magnetic recording disk 13. This results in a change in the voltage or potential of the sensing current in the first and second read wires. This change is detected in the head IC 24. Magnetic bit data is read out of the magnetic recording disk 13 in this manner.

The lower magnetic pole layer 57 of the write head 47 is electrically connected to the slider body 31 through a lead 68. The slider body 31 serves as a ground in this manner. Another pair of electrode terminals, not shown, is located on the surface of the head protection film 32. These electrode terminals are connected to the thin film coil 63 of the write head 47 through leads. A writing current is supplied to the thin film coil 63 in this manner.

The magnetic head 33 enables establishment of the equal capacitances of the first and second read wires. Here, the capacitance of the first read wire includes the capacitances established between the first lead 64 and the slider body 31 and between the upper shielding layer 53 and the lower magnetic pole layer 57. The capacitance of the second read wire includes the capacitances established between the second lead 65 and the slider body 31 and between the lower shielding layer 54 and the slider body 31.

The first and second insulating layers 51a, 51b having different relative permittivities are located between the lower shielding layer 54 and the slider body 31 in the flying head slider 21. Adjustment of the relative permittivities and/or the thicknesses of the first and second insulating layers 51a, 51b, for example, allows a change in the relative permittivity of the insulating layer 51 between the lower shielding layer 54 and the slider body 31. This results in a change in the capacitance between the lower shielding layer 54 and the slider body 31. The capacitances of the first and second read wires can be adjusted in such a facilitated manner. The capacitance of the second read wire can in this manner be set equal to that of the first read wire. The first and second read wires contribute to an accurate readout of magnetic bit data irrespective of noise on the slider body 31.

Here, the insulating layer 51 is located between the first lead 64 and the slider body 31 and between the second lead 65 and the slider body 31. The insulating layer 55 is located between the insulating layer 51 and the first lead 64 and between the insulating layer 51 and the second lead 65. The insulating layer 55 serves to make a predetermined distance between the insulating layer 51 and the first lead 64 and between the insulating layer 51 and the second lead 65. The insulating layer 51 thus hardly influences the capacitances between the first lead 64 and the slider body 31 and between the second lead 65 and the slider body 31.

A tunnel-junction film is utilized as the magnetoresistive film 52, for example. The tunnel-junction film has a significantly high electric resistance. The tunnel-junction film is thus very sensitive to a difference in the potential. Accordingly, the tunnel-junction magnetoresistive element is allowed to particularly enjoy advantages of the present invention. Furthermore, the magnetic head 33 is allowed to maintain the thickness of the insulating layer 51 as ever. The distance can be kept between the lower shielding layer 54 and the slider body 31 as ever in the magnetic head 33. The flying head slider 21 needs not be subjected to a design change. The flying head slider 21 is protected from any change in the flying height. The magnetic characteristic can be maintained in the flying head slider 21.

A wafer made of Al₂O₃—TiC, for example, is first prepared for making the flying head slider 21. The wafer forms the slider body 31. The insulating layer 51 is formed on the surface of the wafer. Sputtering may be employed to form the first and second insulating layers 51a, 51b, for example. In the case where Al₂O₃ is utilized to form the first and second insulating layers 51a, 51b, for example, the speed of film formation may be changed in the sputtering for adjustment of the relative permittivities. The lower shielding layer 54, the magnetoresistive layer 52 and the upper shielding layer 53 may subsequently be formed on the upper surface of the second insulating layer 51b in a conventional manner.

The inventor has observed a relationship between the thicknesses of the first and second insulating layers 51a, 51b and the capacitances of the read wires. A simulation was employed for the observation. The relative permittivity of Al₂O₃ was set at 8.5 for the first insulating layer 51a. The relative permittivity of Al₂O₃ was set at 6.5 fro the second insulating layer 51b. The overall thickness of the insulating layer 51 was kept constant. The thicknesses of the first and second insulating layers 51a, 51b were varies in the insulating layer 51. The ratio was calculated between the capacitances of the first and second read wires.

As shown in FIG. 6, when the thickness of the first insulating layer 51a was set at approximately 40% in the insulating layer 51, for example, the capacitances of the first and second read wires coincided with each other. An increase/decrease in the thicknesses of the first and second insulating layers 51a, 51b has induced an increase/decrease in the ratio between the capacitances. It has been demonstrated that adjustment of the thicknesses and/or the relative permittivities of the first and second insulating layers 51a, 51b within the insulating layer 51 enables adjustment of the capacitances of the first and second read wires.

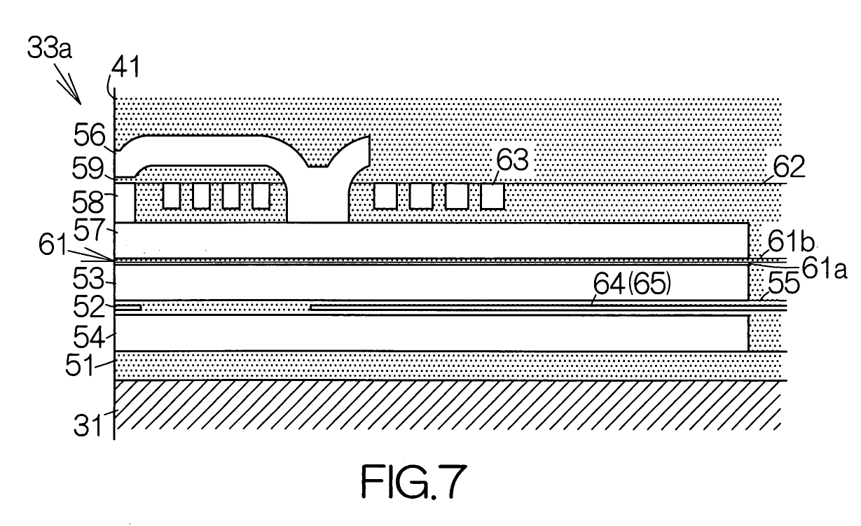

As shown in FIG. 7, a magnetic head 33a may be embedded within the head protection film 32 in place of the aforementioned magnetic head 33. The aforementioned insulating layer 61 includes a first insulating layer 61a having a first thickness and a second insulating layer 61b having a second thickness in the magnetic head 33a. The first insulating layer 61a may be made of a dielectric having a first relative permittivity. The second insulating layer 61b may be made of a dielectric having a second relative permittivity different from the first relative permittivity.

The first insulating layer 61a is formed on the upper surface of the upper shielding layer 53. The second insulating layer 61b is formed on the upper surface of the first insulating layer 61a. The lower magnetic pole layer 57 may be received on the upper surface of the first insulating layer 61a. It should be noted that the first insulating layer 61a may be formed on the upper surface of the second insulating layer 61b. The aforementioned insulating layer 51 may be made of a single layer of Al₂O₃. Like reference numerals are attached to structure or components equivalent to those of the aforementioned magnetic head 33.

Adjustment of the relative permittivities and/or the thicknesses of the first and second insulating layer 61a, 61b allows a change in the relative permittivity of the insulating layer 61 between the lower magnetic pole layer 57 and the upper shielding layer 53. This results in a change in the capacitance between the lower magnetic pole layer 57 and the upper shielding layer 53. The capacitances of the first and second read wires can be adjusted in such a facilitated manner. The capacitances of the second read wire can in this manner be set equal to that of the first read wire. In this manner, the magnetic head 33a is allowed to enjoy the advantages identical to those obtained in the aforementioned embodiment.

The insulating layers 51, 61 may have a layered structure made of three or more insulating layers in the magnetic head 33, 33a. In this case, the relative permittivity and the thickness may individually be adjusted for the insulating layers.

What is claimed is:

1. A magnetic head comprising:
a lower shielding layer formed on a slider body;
an upper shielding layer extending along a plane parallel to the lower shielding layer; and
a read element located between the lower and upper shielding layers, the read element electrically connected separately to the lower and upper shielding layers, respectively, wherein
a first insulating layer having a first thickness and a second insulating layer having a second thickness are located between the lower shielding layer and the slider body, said first insulating layer having a first relative permittivity, said second insulating layer having a second relative permittivity larger than the first relative permittivity.

2. A storage device comprising:
an enclosure;
a head slider enclosed in the enclosure, said head slider having a slider body;
a lower shielding layer formed on the slider body;
an upper shielding layer extending along a plane parallel to the lower shielding layer; and
a read element located between the lower and upper shielding layers, the read element electrically connected separately to the lower and upper shielding layers, respectively, wherein
a first insulating layer having a first thickness and a second insulating layer having a second thickness are located between the lower shielding layer and the slider body, said first insulating layer having a first relative permittivity, said second insulating layer having a second relative permittivity larger than the first relative permittivity.

3. A magnetic head comprising:
a lower shielding layer formed on a slider body;
an upper shielding layer extending along a plane parallel to the lower shielding layer;
a read element located between the lower and upper shielding layers, the read element electrically connected separately to the lower and upper shielding layers, respectively; and
a magnetic pole layer extending along a plane parallel to the upper shielding layer, wherein
a first insulating layer having a first thickness and a second insulating layer having a second thickness are located between the magnetic pole layer and the upper shielding layer, said first insulating layer having a first relative permittivity, said second insulating layer having a second relative permittivity larger than the first relative permittivity.

4. A storage device comprising:
an enclosure;
a head slider enclosed in the enclosure, said head slider having a slider body;
a lower shielding layer formed on the slider body;
an upper shielding layer extending along a plane parallel to the lower shielding layer;
a read element located between the lower and upper shielding layers, the read element electrically connected separately to the lower and upper shielding layers, respectively; and
a magnetic pole layer extending along a plane parallel to the upper shielding layer, wherein
a first insulating layer having a first thickness and a second insulating layer having a second thickness are located between the magnetic pole layer and the upper shielding layer, said first insulating layer having a first relative permittivity, said second insulating layer having a second relative permittivity larger than the first relative permittivity.
